(19) United States
(12) Patent Application Publication
(10) Pub. No.: US 2009/0046319 A1
(43) Pub. Date: Feb. 19, 2009

(54) PRINTING SYSTEM, PRINTING APPARATUS, METHOD FOR PRINTING, AND COMPUTER USABLE MEDIUM THEREFOR

(75) Inventor: Yuki FUKUSADA, Kasugai (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/189,395

(22) Filed: Aug. 11, 2008

(30) Foreign Application Priority Data
Aug. 15, 2007 (JP) 2007-211866

(51) Int. Cl. G06F 3/12

(52) U.S. Cl. 358/1.15

(57) ABSTRACT

A printing system capable of processing a plurality of print jobs is provided. The printing system includes a plurality of information processing apparatuses, each of which generates a print job based on print data representing an image to be printed and transmits the print job to a printing apparatus, and a printing apparatus, which forms images based on the plurality of print jobs received. The information processing apparatus includes a priority information appending unit to append first priority information, representing a priority level of the print job, and second priority information, representing a priority level of a user who operates the information processing apparatus to generate the print job, to the print job. The printing apparatus includes an order establishing unit to establish an order to print the images based on the first priority information and the second priority information appended to the print jobs.

### CROSS REFERENCE TO RELATED APPLICATION

This application claims priority from Japanese Patent Application No. 2007-211866, filed on Aug. 15, 2007, the entire subject matter of which is incorporated herein by reference.

### BACKGROUND

1. Technical Field

An aspect of the present invention relates to a printing system, a printing apparatus, and a computer usable medium therefor.

2. Related Art

In a printing system having a printer and a plurality of terminal computers which share the printer, for example, a plurality of print jobs can be passed to the printer (or a printer server, which will be hereinafter also referred to as a printer). In such a case, generally, the printer processes the print jobs in an order in which the print jobs are received.

However, depending on characteristics of the print jobs (i.e., printed outputs), it may not be necessarily practical to process the print jobs in the received order, but may be useful to process the print jobs in a particular order other than the received order. In Japanese Patent Provisional Publication No. 2004-343655, for example, a printing system, in which the print jobs are processed in a prioritized order according to priorities assigned to the users, is disclosed.

### SUMMARY

In the printing system according to the above-referenced publication, the print jobs are uniformly prioritized according to the predetermined priority assigned to each user. Therefore, for example, when the priority of a user A is higher than the priority of a user B, a print job provided by the user A is processed prior to a print job provided by the user B whenever the print job from the user A is provided regardless of urgency of the print job from the user B. In other words, the order to be processed, which is determined on the user basis, does not necessarily provide practical convenience.

In consideration of the above practicality, the present invention is advantageous in that a printing system, a printing apparatus, and a computer usable medium therefore, which can process the print jobs in a practically suitable order, are provided.

According to an aspect of the present invention, a printing system capable of processing a plurality of print jobs is provided. The printing system includes a plurality of information processing apparatuses, each of which is capable of generating a print job based on print data representing an image to be printed and is adapted to transmit the print job to a printing apparatus, and a printing apparatus, which is capable of forming images based on the plurality of print jobs transmitted from the plurality of information processing apparatuses. Each of the information processing apparatuses is provided with a priority information appending unit to append first priority information and second priority information to the print job. The first priority information represents a priority level of the print job, and the second priority information represents a priority level of a user who operates the information processing apparatus to generate the print job. The printing apparatus is provided with an order establishing unit to establish an order to print the images based on the first priority information and the second priority information appended to the print jobs.

According to another aspect of the present invention, a printing system capable of processing a plurality of print jobs is provided. The printing system includes a plurality of information processing apparatuses, each of which is capable of generating a print job based on print data representing an image to be printed and is adapted to transmit the print job to a printing apparatus, a printing apparatus, which is capable of forming images based on the plurality of print jobs transmitted from the plurality of information processing apparatuses, an information appending unit to append first priority information and second priority information to the print job, in which the first priority information represents a priority level of the print job, and the second priority information represents a priority level of a user who operates the information processing apparatus to generate the print job, and an order establishing unit to establish an order to print the images based on the first priority information and the second priority information appended to the print jobs.

According to still another aspect of the present invention, a printing apparatus is provided. The printing apparatus includes a receiving unit to receive plurality of print jobs generated in and transmitted from a plurality of information apparatuses, an order establishing unit to establish an order to process the print jobs to print images based on first priority information and second priority information appended to each of the print jobs, in which the first priority information representing a priority level of the print job, and second priority information representing a priority level of a user who operates the information processing apparatus to generate the print job, and a printing unit to print the images corresponding to the print jobs based on the order established by the order establishing unit.

According to another aspect of the present invention, a method to operate a printing system including a plurality of information processing apparatuses and a printing apparatus to process a plurality of print jobs is provided. The method includes generating a print job and appending first priority information, which represents a priority level of the print job, and second priority information, which represents a priority level of a user who operates the information processing apparatus to generate the print job, to the print job, establishing an order to process the print jobs to print images based on the first priority information and the second priority information appended to each of the print jobs, and printing the images corresponding to the print jobs based on the order established by the order establishing unit.

According to another aspect of the present invention, a computer usable medium including computer readable instructions to control a printing system including a plurality of information processing apparatuses and a printing apparatus to process a plurality of print jobs is provided. The computer readable instructions control the printing system by executing steps of generating a print job and appending first priority information, which represents a priority level of the print job, and second priority information, which represents a priority level of a user who operates the information processing apparatus to generate the print job, to the print job, establishing an order to process the print jobs to print images based on the first priority information and the second priority information appended to each of the print jobs; and, printing the images corresponding to the print jobs based on the order established by the order establishing unit.

According to the above configurations, the order to print the images, which are included in the print jobs provided by a plurality of users, is determined in consideration of the first priority information being set on the print job basis in addition to the second priority information being set on the user basis; therefore, the images can be printed in consideration of the urgencies of the print jobs and attributes of the users, and usage of the printing system can be improved.

### BRIEF DESCRIPTION OF THE ACCOMPANYING DRAWINGS

FIG. 1 is a block diagram to schematically illustrate a printing system according to a first embodiment of the present invention.

FIG. 2 schematically illustrates a priority table used in the printing system according to the first embodiment of the present invention.

FIG. 3 schematically illustrates a printing order determined based on the priority table according to the first embodiment of the present invention.

FIGS. 4A and 4B schematically illustrate printing orders determined based on the priority table according to the first embodiment of the present invention.

FIG. 5 is a flowchart to illustrate a process to create and transmit a print job to a printer in the printing system according to the first embodiment of the present invention.

FIG. 6 illustrates a priority setting window through which a user sets priority for a print job according to the first embodiment of the present invention.

FIG. 7 is a flowchart to illustrate a process to be executed in the printing system according to a second embodiment of the present invention.

FIG. 8 illustrates a window through which the user sets the priority for a print job in the printing system according to a third embodiment of the present invention.

FIG. 9 illustrates a preset urgency table to be used in the printing system according to the third embodiment of the present invention.

FIG. 10 is a flowchart to illustrate a process to be executed in the printing system according to the third embodiment of the present invention.

FIG. 11 is a flowchart to illustrate a process to be executed in the printing system according to a fourth embodiment of the present invention.

FIG. 12 is a flowchart to illustrate a process to be executed in the printing system according to the fourth embodiment of the present invention.

FIG. 13 is a flowchart to illustrate a process to be executed in the printing system according to a fifth embodiment of the present invention.

FIG. 14 is a flowchart to illustrate a process to be executed in the printing system according to the fifth embodiment of the present invention.

FIG. 15 illustrates a user administration window to be used by an administrator of the printing system 1 according to a sixth embodiment of the present invention

FIG. 16 schematically illustrates a print job administration table to be used in the printing system according to the sixth embodiment of the present invention.

FIG. 17 schematically illustrates calculated priorities of the print jobs to be processed in the printer according to the sixth embodiments of the present invention.

FIG. 18 schematically illustrates calculated priorities of the print jobs to be processed in the printer according to the sixth embodiments of the present invention.

### DETAILED DESCRIPTION

Hereinafter, embodiments according to aspects of the present invention will be described with reference to the accompanying drawings.

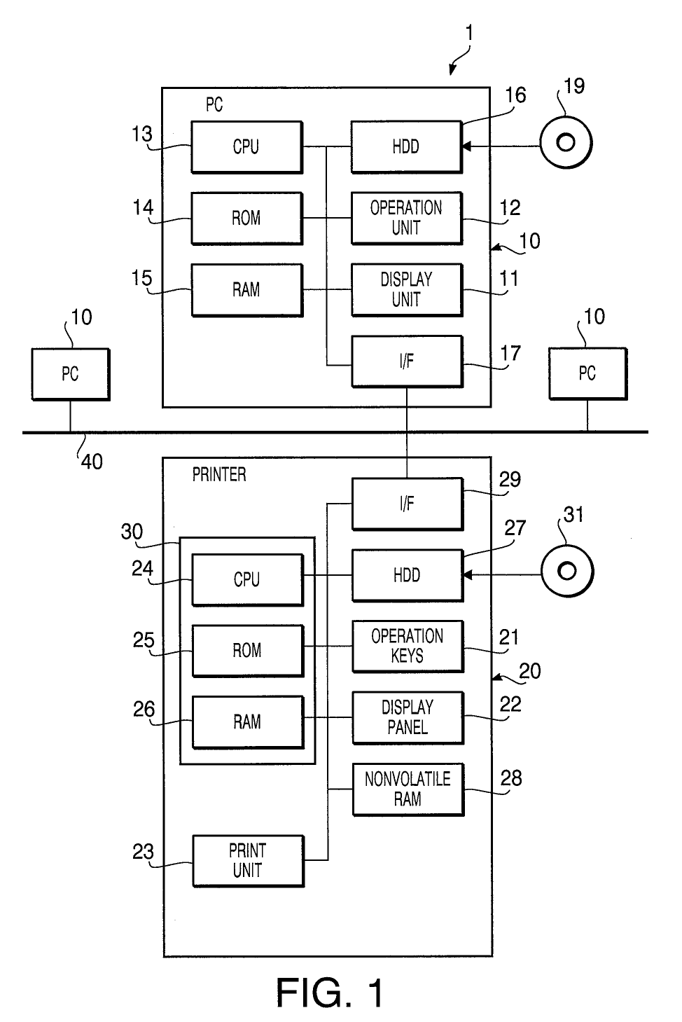

FIG. 1 is a block diagram to schematically illustrate a printing system 1 according to a first embodiment of the present invention. The printing system 1 includes a plurality of PCs (personal computers) 10 and a printer 20. Each of the PCs 10 is an information processing apparatus having a display unit 11, an operation unit 12, a CPU 13, memory units including a ROM 14, a RAM 15, and an HDD 16, and an I/F (interface) unit 17, through which PC 10 is connected with a LAN (local area network) 40 and with external devices.

The display unit 11 includes a displaying screen (not shown) such as an LCD (liquid crystal display) and a CRT (cathode-ray tube) to display images (including figures and characters). The operation unit 12 includes a pointing device such as a mouse (not shown) to move a pointer (not shown), which specifies a desired portion on the screen, and a keyboard (not shown).

The printer 20 includes operation keys 21, through which a user enters selection of usable functionality of the printer 20 and various parameters to operate the printer 20, a display panel 22 to display various operational information concerning the printer 20 such as operation status, a printing unit 23 to form an image on a recording medium such as paper, a CPU 24 to control each unit in the printer 20, memory units such as a ROM 25, a RAM 26, and an HDD 27.

The printer 20 further includes a nonvolatile RAM 28, which is a memory unit capable of maintaining stored data even when power supply thereto is stopped, and an I/F unit 29, through which the printer 20 is connected with the LAN 40 and to the PCs 10. Thus, the printer 20 can be shared with the plurality of PCs 10 provided in the network.

In the present embodiment, the CPU 24, the ROM 25, and the RAM 26 constitute a control unit 30, which controls operations of the components in the printer 20 such as the printing unit 23 and the display panel 22 according to programs stored in the ROM 25.

The operations of the printing system 1 according to the present embodiment are controlled by programs, such as a printer driver 19, which is installed in a storage unit (e.g., the HDD 16) and run in the PCs 10, and a controlling program 31, which is installed in a storage unit (e.g., the HDD 27) and run in the printer 20. Thus, print jobs generated in the PCs 10 are respectively transmitted to the printer 20 to be processed through the LAN 40 so that images according to the print jobs are printed on the recording media by the printer 20.

Next, operations to be performed in the printing system 1 will be described. In the present embodiment, an order to process the transmitted print jobs (hereinafter referred to as a printing order) are determined based on first priority information assigned to each print job and on second priority information assigned to each user who provides the print job. The prioritized print jobs are thereafter processed according to the determined order.

FIG. 6 illustrates a priority setting window 100a through which the user sets the priority for the print job according to the first embodiment of the present invention. When the user requests the PC 10 to generate a print job, the priority setting window 100a as shown in FIG. 6 is displayed on the screen of the display unit 11. The user is thus prompted to specify an urgency level and a usage authority level.

In the present embodiment, the parameter to indicate the urgency level can be set as the user selects one of “high,” “normal,” and “low” displayed in an urgency level designation box 101. The usage authority level can be set as the user selects one of authority levels from 1 to 5 presented in a usage authority level input field 102. In the present embodiment, the authority level 1 indicates the highest priority, while the authority level 5 indicates the lowest priority. As the number becomes larger, the priority level becomes lower.

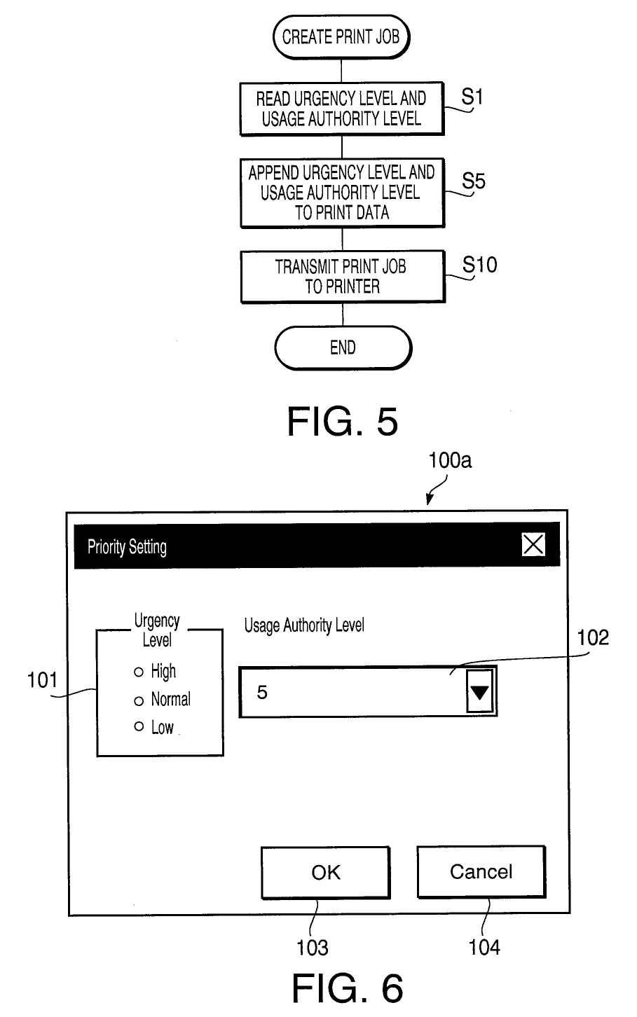

When the user presses an OK button 103 with the urgency level and the usage authority level being selected, a process (see FIG. 5) to create a print job and transmit the created print job to the printer 20 through the I/F unit 17 is activated in the PC 10.

The print job according to the present embodiment includes print data, which is generated based on image data representing an image to be printed, and the appended information concerning the urgency level and the usage authority level. The print job is described in a specific format supported by the printer 20, which can be operated in PDL (page description language) format. The format of the print job is determined depending on a type of the printer in which the print job is processed.

The print data is generated in an application software (e.g., a word processing application) running in the PC 10. In many cases, the application software capable of creating and editing the print data is installed in a storage unit such as the HDD 16 in the PC 10.

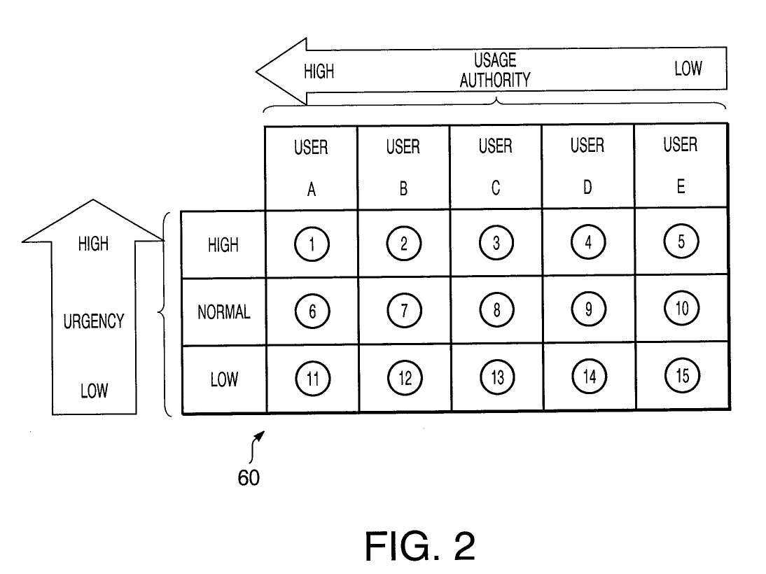

The printer 20 receiving the print job through the I/F unit 29 settles an order to process a plurality of print jobs transmitted to the printer 20 based on a priority table 60 (see FIG. 2) and processes the print jobs to form images respectively on recording media.

When a cancel button 104 (see FIG. 6) in the priority setting window 100a is pressed while the priority setting window 100a is displayed, the request for generating the print job is canceled.

The process to create the print job and transmit the created print job to the printer 20 will be described hereinbelow. FIG. 5 is a flowchart to illustrate the process to be performed in the PC 10 of the printing system 1 according to the first embodiment of the present invention. The process is activated in the PC 10 when the OK button 103 in the priority setting window 100a is pressed. When the process is activated, in S1, the CPU 13 reads the urgency level and the usage authority level selected in the priority setting window 100a.

Following S1, in S5, the urgency level and the usage authority level read in S1 are appended to the print data created based on the image data to generate the print job. Following S5, in S10, the generated print job is transmitted to the printer 20. The process is terminated thereafter.

In the present embodiment, the print job also includes information to identify the user who provided the request for generating the print job to the PC 10. Further, the printer driver 19 is configured such that the PC 10 identifies the user based on a user name being entered when the user logs in the PC 10 so that the usage authority level preliminarily given to the user is inputted to be displayed in the usage authority level input field 102 upon activation of the priority setting window 100a.

Therefore, the usage authority level preliminarily assigned to the user is adopted as a default level for the usage authority level of print jobs requested by the user unless the user alters the levels. Meanwhile, the urgency level is set on the request basis. Thus, the usage authority level included in the generated print job reflects the specific priority assigned to the user. In other words, the usage authority level of print job can be arbitrarily altered by the user within the highest level and the lowest level.

Next, a priority table 60 to be used to establish the printing order in the printing system 1 will be described. FIG. 2 schematically illustrates the priority table 60 used to establish the printing order in the printing system 1 according to the first embodiment of the present invention. The priority table 60 is stored in the memory unit such as the nonvolatile RAM 28 or the ROM 25 of the printer 20. According to the present embodiment, the vertical direction (columns) in the priority table 60 represents the urgency level, and the horizontal direction (lines) represents the usage authority level. Encircled figures arranged in the priority table 60 represent priority levels of the print jobs, and the smaller becomes the number, the higher becomes the priority (i.e., a number 1 represents the highest priority, while a number 15 represents the lowest priority).

When the urgency levels of a plurality of print jobs are equivalent, in one of the horizontal lines, the priorities of the print jobs are determined based on the usage authority levels set to the respective print jobs through the priority setting window 100a and/or assigned preliminarily to the users. When a plurality of print jobs are provided by one user, in one of the vertical columns, the priorities of the print jobs are determined based on the urgency levels set to the respective print jobs.

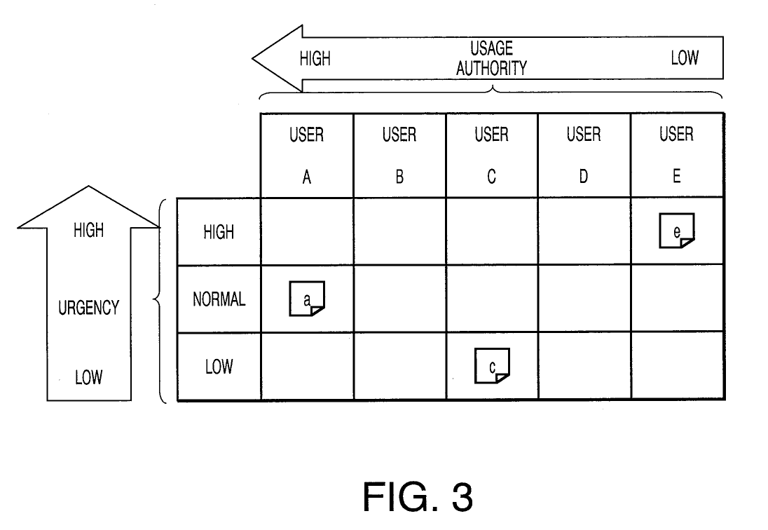

Next, a process to establish the printing order for the plurality of print jobs received in the printer 20 will be described. FIG. 3 schematically illustrates the printing order to be determined based on the priority table 60 according to the first embodiment of the present invention. With reference to FIG. 3, a first example according to the present embodiment, in which print jobs (a), (c), and (e) are provided to the printer 20 by a user A, a user C, and a user E respectively, will be described. Urgency levels of the print jobs (a), (c), and (e) are respectively set to be normal, low, and high. Further, in the present example, it is assumed that no other print job is waiting in the printer 20 to be processed, and the print jobs (a), (c), (e) are received in the printer 20 in the order given.

The priorities of the print jobs (a), (c), (e) are arranged in the fields as shown in FIG. 3 based on the urgency levels. It is to be noted in the present example that the user A is admitted the highest user authority level, the user C is the second highest, and the user E is the lowest user authority among the three users. When the priority table shown in FIG. 3 is applied to the priority table 60 shown in FIG. 2, it is noted that the fields, in which the print jobs (a), (c), (e) are arranged, correspond to the encircled numbers 6, 13, and 5 respectively. Therefore, it is determined that the priorities for the print jobs (e), (a), (c) are the highest, the second highest, and the lowest, respectively. Thus, the printing order, in which the print jobs (e), (a), (c) are processed in the order given, is established.

It is to be noted that, in the present embodiment, when the priorities of a plurality of print jobs are determined to be equivalent according to the priority table 60, the print jobs are processed in the received order, in which the print jobs are received in the printer 20.

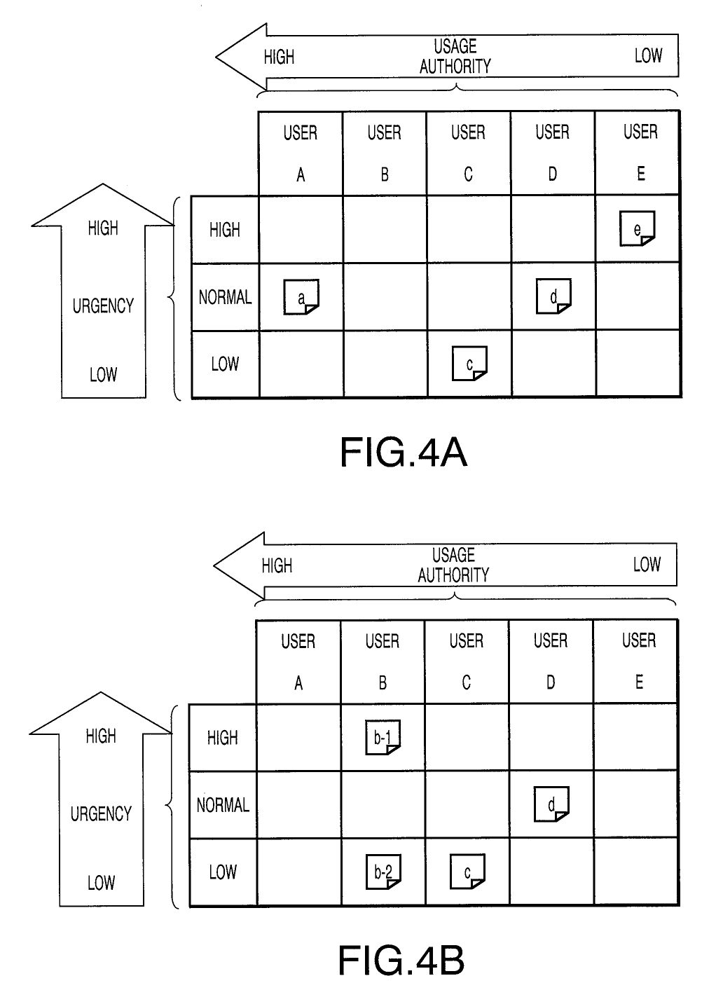

A second example will be described hereinbelow with reference to FIGS. 4A and 4B. FIGS. 4A and 4B schematically illustrate the printing orders determined based on the priority table 60 according to the first embodiment of the present invention. In the present example, print jobs (a), (c), (d), and (e) are provided to the printer 20 by a user A, a user C, a user D, and a user E respectively. Urgency levels of the print jobs (a), (c), (d), and (e) are respectively set to be normal, low, normal, and high. Further, in the present example, it is assumed that no other print job is waiting in the printer 20 to be processed, and the print jobs (a), (c), (d), (e) are received in the printer 20 in the order given.

The priorities of the print jobs (a), (c), (d), (e) are arranged in the fields as shown in FIG. 4A based on the urgency levels. It is to be noted in the present example that the user A is admitted the highest user authority level, the user C is the second highest, the user D is the third highest, and the user E is the lowest user authority among the four users. When the priority table shown in FIG. 4A is applied to the priority table 60 shown in FIG. 2, it is noted that the fields, in which the print jobs (a), (c), (d), (e) are arranged, correspond to the encircled numbers 6, 13, 9, and 5 respectively. Therefore, it is determined that the priorities for the print jobs (e), (a), (d), (c) are the highest, the second highest, the third highest, and the lowest, respectively. Thus, the printing order, in which the print jobs (e), (a), (d), (c) are processed in the order given, is established.

In the present example, it is assumed that after the print job (e) is completed and while the print job (a) is in progress, the printer 20 receives new print jobs b-1, b-2 from a user B, in the order given. Accordingly, the printing order for the entire print jobs yet to be processed (i.e., the print jobs b-1, b-2, (c), (d)) will be reestablished. It is to be noted that the printing order is reestablished each time when a new print job is received in the printer 20; however, in the present example, solely reestablishment of the printing order when the print job b-2 is received in the printer 20 will be described, and reestablishment of the printing order when the print job b-1 is received is omitted for simplicity in explanation.

In the present example the user B is admitted the second highest level of the usage authority, which falls between the usage authority levels of the user A and the user C. Further, the urgency levels of the print jobs b-1 and b-2 are set to be high and low, respectively.

The priorities of the unprocessed print jobs b-1, b-2, (c), (d) are arranged in the fields as shown in FIG. 4B based on the urgency levels. When the priority table shown in FIG. 4B is applied to the priority table 60 shown in FIG. 2, it is noted that the fields, in which the print jobs b-1, b-2, (c), (d) are arranged, correspond to the encircled numbers 2, 12, 13, and 9 respectively. Therefore, it is determined that the priorities for the print jobs b-1, (d), b-2, and (c) are the highest, the second highest, the third highest, and the lowest, respectively. Thus, the printing order, in which the print jobs b-1, (d), b-2, (c) are processed in the order given, is established.

According to the present embodiment, as described above, the urgency levels set to each of the print jobs is taken into account in connection with the usage authority levels, which are set to each of the users, in order to determine the printing order. Thus, usability of the printing system 1 can be improved.

Further, according to the present embodiment, the user can set at least one of the urgency level and the usage authority level on the print job basis; therefore, the priority for the print job can be effectively adjusted in consideration with the urgency levels and the usage authority levels of the other print jobs received in the printer 20.

Next, a second embodiment according to the present invention will be described. In the second embodiment, a plurality of interrelated print jobs are bundled as one print job and arranged in the printing order based on the urgency levels and the usage authority levels set to the print jobs.

The interrelated print jobs according to the present embodiment refer to print jobs which are requested by one user and generated to print a plurality of copies of an identical image. Further, when a print job us divided into a plurality of smaller print jobs, divided by a user or the printer driver 19 since a total number of pages for the original print job is relatively large, the divided print jobs can be referred to as a plurality of interrelated print jobs. The interrelated print jobs configure a print job group.

Each of the print jobs in a print job group includes grouping information, which indicates belongingness of the print job to the print job group and identification of the print job group. The printer 20 thus assumes the plurality of interrelated print jobs having the grouping information as one print job and processes the plurality of print jobs successively.

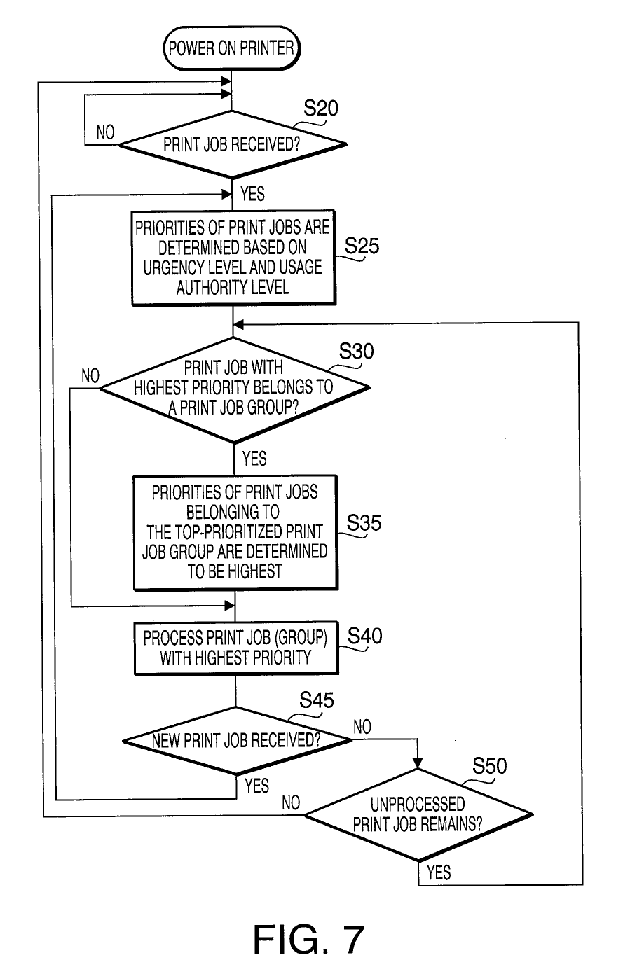

Hereinafter, a process to determine a print job, or a print job group, with a highest priority to be executed in the printing system 1 according to the second embodiment will be described. FIG. 7 is a flowchart to illustrate the process to be executed in the printing system 1 according to the second embodiment of the present invention.

The process is initiated when the printer 20 is powered on and terminated when power supply to the printer 20 is shut off. When the printer 20 is powered on, in S20, the CPU 24 determines as to whether a print job is received. If no print job is received (S20: NO), the CPU 24 enters a ready state and waits for input.

In S20, if a print job is received (S20: YES), in S25, a printing order with respect to the other unprocessed print jobs remaining in the printer 20 is established in a method similar to the establishment of the printing order described in the previous embodiment according to the urgency level and the usage authority level. The print job received in the printer 20 is stored in the HDD 27 of the printer 20 and removed therefrom when a printing operation corresponding to the print job is completed. In S25, priority of the print job received in S20 and the other remaining print jobs is determined based on the urgency levels and the usage authority levels appended to the print jobs, regardless of the grouping information.

Thereafter, in S30, it is judged to determine as to whether the print job determined to have the highest priority in S25 (hereinafter referred to as a top-prioritized print job) belongs to any print job group based on the grouping information appended to the print jobs. The print job group to which the top-prioritized print job belongs will be hereinafter referred to as a top-prioritized print job group.

If the top-prioritized print job belongs to a print job group (S30: YES), in S35, priorities of the entire print jobs belonging to the top-prioritized print job group are equally determined to be the highest, and the plurality of print jobs are included in one print job. Thus, the print job group including the interrelated print jobs is processed in the order established according to the priority of the top-prioritized print job among the interrelated print jobs within the print job group. Following S35, in S40, the plurality of print jobs included in one print jobs are successively processed.

In S30, if the print job determined to have the highest priority in S25 does not belong to any print job group (S30: NO), in S40, solely the print job with the highest priority is processed. Thereafter, in S45, it is judged to determine as to whether a new print job is received. If a new print job is received (S45: YES), S25 is repeated.

In S45, if no print job is received (S45: NO), in S50, it is determined as to whether an unprocessed print job remains. If an unprocessed print job remains (S50: YES), S30 is repeated. If no unprocessed print job remains (S50: NO), the process returns to S20.

According to the second embodiment described above, a plurality of print jobs which belong to one print job group are entirely counted as one print job so that the plurality of print jobs are set to have the equivalent priority in the printing order. Therefore, for example, when a plurality of copies of an identical image are in process to be printed, the print job can be prevented from being interrupted by a newly-received print job in between the identical copies. Thus, usability of the printing system 1 can be improved.

In the second embodiment, the priorities of the print jobs are determined regardless of belongingness of the print jobs to a print job group, but the belongingness of the print job with the highest priority is considered after the determination of the printing order. However, belongingness of a plurality of print jobs can be considered prior to determining the printing order. That is, a plurality of print jobs belonging to one print job group can be counted as one print job, and the priority of the print job group can be determined based on an urgency level and a usage authority level of a print job which was received in the printer 20 firstly among the plurality of print jobs in the print job group.

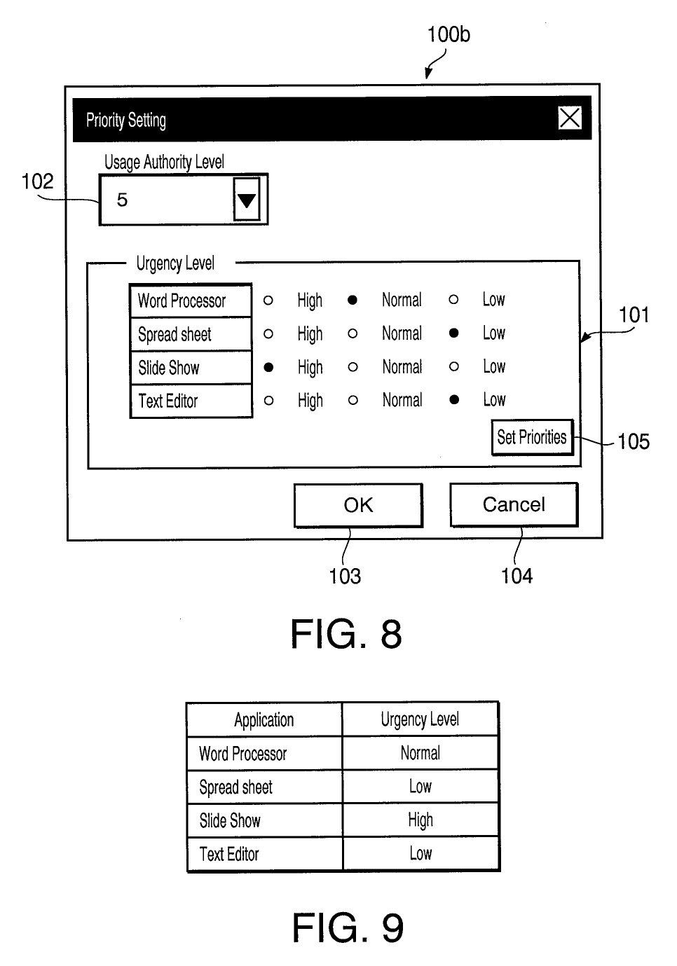

Next, a third embodiment according to the present invention will be described with reference to FIGS. 8-10. FIG. 8 illustrates a priority setting window 100b through which a user sets priority for a print job in the printing system 1 according to the third embodiment of the present invention. In the third embodiment, an urgency level of a print job is determined according to a type of print data included in a print job.

As shown in FIG. 8, the urgency levels can be set on basis of a type of frequently-used application software which is used to create and edit a data file included in a print job. The urgency level for each application software is preliminarily set, for example, as shown in a table in FIG. 9. FIG. 9 illustrates a preset urgency table to be referred to when the priority setting window 100b is activated in the PC 10 of the printing system 1 according to the third embodiment of the present invention. The preset urgency table is stored in at least one of the memory units of the printer 20, such as the RAM 28 and the ROM 25.

When the priority setting window 100b is displayed, the user can select one of the urgency levels high, normal, and low on basis of the application software. When a set priority button 105 is pressed, the priority settings as shown in the priority setting window 100b are applied to the application software. When no pressing operation is given to the set priority button 105, but an OK button 103 is pressed, one of the priority settings as shown in the priority setting window 100b is applied to a print job currently being generated.

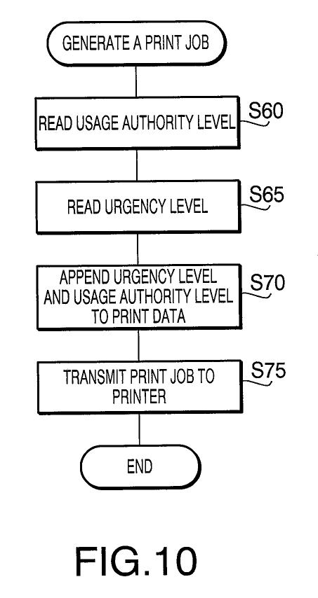

FIG. 10 is a flowchart to illustrate a controlling process to be activated when the OK button 103 is pressed and executed by the printer driver 19 of the PC 10 in the printing system 1 according to the third embodiment of the present invention. When the OK button 103 is pressed and the process is activated, in S60, a usage authority level preliminarily set to the user and displayed in the usage authority level input field 102 is read.

Thereafter, in S65, an urgency level corresponding to the application software, which is used to create the print data currently being in process, selected by the user and displayed in the urgency level designation box 101 is read. In the present embodiment, the application software can be identified by an extension of the data file (e.g., “.doc”, “.xls”, “.ppt”, “.txt”). Further, in S70, the urgency level read in S65 and the usage authority level read in S60 are appended to the print data to generate a print job. Following S70, in S75, the generated print job is transmitted to the printer 20. The process is terminated thereafter.

According to the third embodiment, the urgency level for the print job is determined based on a data type of the data file to be printed so that usability of the printing system 1 can be improved.

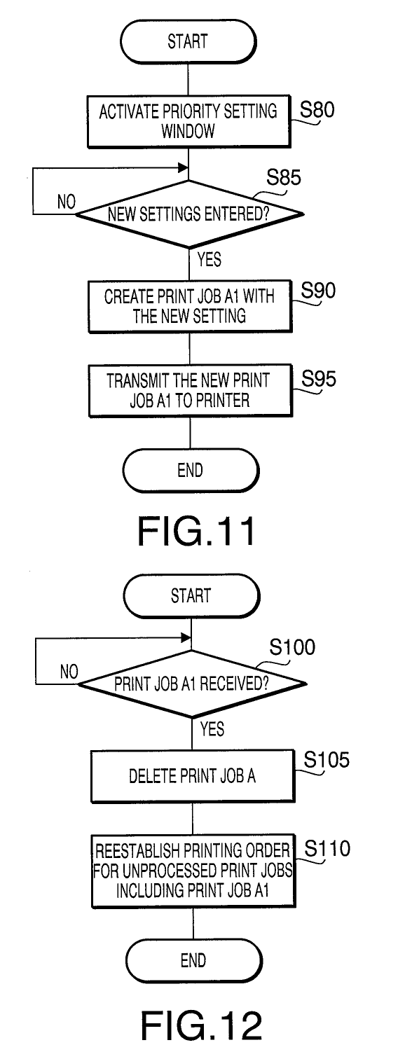

Next, a fourth embodiment according to the present invention will be described with reference to FIGS. 11 and 12. FIG. 11 is a flowchart to illustrate a controlling process to change the priority setting of a print job to be executed in the PC 10 of the printing system 1 according to the fourth embodiment of the present invention. In the present embodiment, at least one of an urgency level and a usage authority level set to a print job can be altered. The following description explains a case in which the urgency level of a print job is altered.

The controlling process shown in FIG. 11 is activated when a property of a print job, which is a backup copy of a print job transmitted to the printer 20 and stored in one of the memory units of the PC 10, is referred to. Incidentally, in the present embodiment, the backup copy of the print job is removed from the memory unit when a printing process for the corresponding print job is completed and a signal to indicate the completion is received in the PC 10.

When an urgency level of a print job A is to be altered, a property of the backup copy of the print job A is referred to. When the property is opened to be edited, and when the user enters a command to alter the urgency level, the controlling process shown in FIG. 11 is activated. In S80, a priority setting window 100a (see FIG. 6) is presented. Thereafter, in S85, it is determined as to whether a new setting for the urgency level is entered (i.e., the OK button 103 is pressed).

In S85, if a new setting is entered (S85: YES), in S90, a print job A1 with the new urgency level is created based on the backup copy of the print job A in the memory unit of the PC 10. In S95, the print job A1 is transmitted to the printer 20. The process is terminated thereafter.

During the above process, when the print job A1 is created (in S90), information to identify the origin of the print A1 (i.e., the print job A) and information to indicate that at least one of the urgency level and the usage authority level is altered are appended. Further, a backup copy of the print job A1 is created and stored in one of the memory units of the PC 10 as well.

FIG. 12 is a flowchart to illustrate a controlling process to change the priority setting of a print job to be executed in the printer 20 of the printing system 1 according to the fourth embodiment of the present invention. The controlling process is activated when the printer 20 is powered on and terminated when the power supply to the printer 20 is shut off. The controlling process can be executed in parallel with the other processes (e.g., the process shown in FIG. 7) which are activated upon power-on to the printer 20.

When the CPU 24 activates the controlling process, in S100, it is determined as to whether a print job (i.e., the print job A1) with at least one of the urgency level and the usage authority level being altered is received. If no print job with the altered priority levels is received (S100: NO), the CPU 24 enters a ready state and waits for input.

In S100, if a print job (i.e., the print job A1) with at least one of the urgency level and the usage authority level being altered is received (S100: YES), in S105, an original print job (i.e., the print job A) of the received print job A1 among unprocessed print jobs stored in the memory unit (e.g., the HDD 27) is deleted.

Thereafter, in S110, a new printing order for the unprocessed print jobs including the newly-received print job A1 is reestablished. Thereafter, the CPU 24 enters a ready state and waits for input. The printer 20 thus processes the print jobs remaining in the memory unit in the reestablished printing order.

According to the present embodiment, at least one of the urgency level and the usage authority level, which are once set to a print job, can be altered after the print job is transmitted to the printer 20, and once established printing order can be modified to include the print job with the new priority settings. Thus, usability of the printing system 1 can be improved.

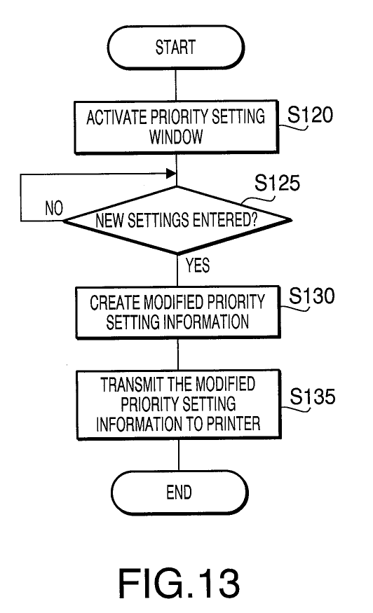

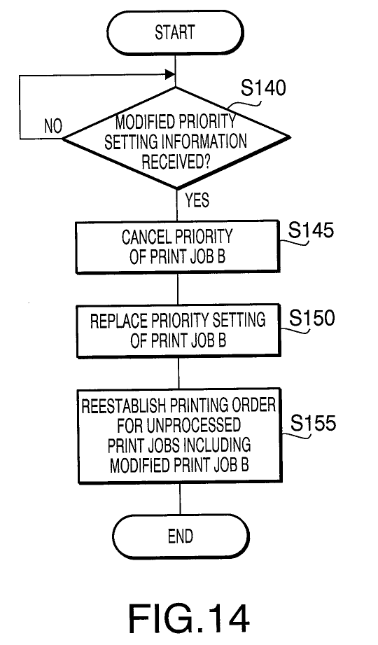

Next, a fifth embodiment according to the present invention will be described with reference to FIGS. 13 and 14. It is to be noted in the fourth embodiment that the entire print job A including the print data is replaced with the print job A1 with the print data and the altered priority settings. Meanwhile, in the fifth embodiment, altered priority settings are transmitted to the printer 20 without the print data so that the printing order can be modified in the printer 20 in consideration of the newly-received priority settings.

FIG. 13 is a flowchart to illustrate a controlling process to change the priority setting of a print job to be executed in the PC 10 of the printing system 1 according to the fifth embodiment of the present invention. In the present embodiment, at least one of an urgency level and a usage authority level set to a print job can be altered. The following description explains a case in which the urgency level of a print job is altered.

The controlling process shown in FIG. 13 is activated when a property of a print job, which is a backup copy of a print job transmitted to the printer 20 and stored in one of the memory units of the PC 10, is referred to.

When an urgency level of a print job B is to be altered, a property of the backup copy of the print job B is referred to. When the property is opened to be edited, and when the user enters a command to alter the urgency level, the controlling process shown in FIG. 13 is activated. In S120, a priority setting window 100a (see FIG. 6) is presented. Thereafter, in S125, it is determined as to whether a new setting for the urgency level is entered (i.e., the OK button 103 is pressed).

In S125, if a new setting is entered (S125: YES), in S130, modified priority setting information, which includes information to indicate the altered urgency level, information to identify the original print job (i.e., the print job B), and information to indicate usage of the modified priority setting information (i.e., to alter the priority settings), is created. Thereafter, in S135, the modified priority setting information is transmitted to the printer 20. The controlling process in the PC 10 is terminated thereafter.

FIG. 14 is a flowchart to illustrate a controlling process to change the priority setting of a print job to be executed in the printer 20 of the printing system 1 according to the fifth embodiment of the present invention. The controlling process is activated when the printer 20 is powered on and terminated when the power supply to the printer 20 is shut off. The controlling process can be executed in parallel with the other processes (e.g., the process shown in FIG. 7) which are activated upon power-on to the printer 20.

When the CPU 24 activates the controlling process, in S140, it is determined as to whether modified priority setting information is received. If no modified priority setting information is received (S140: NO), the CPU 24 enters a ready state and waits for input.

In S140, if modified priority setting information is received (S140: YES), in S145, a print job (i.e., the print job B) corresponding to the modified priority setting information being received is searched among unprocessed print jobs stored in the memory unit (e.g., the HDD 27), and the priority of the print job B being found is canceled.

Thereafter, in S150, the priority settings of the print job B are replaced with the priority settings included in the modified priority setting information being received in S140.

In S155, a new printing order for the unprocessed print jobs including the modified print job B is reestablished. Thereafter, the CPU 24 enters a ready state and waits for input. The printer 20 thus processes the print jobs remaining in the memory unit in the reestablished printing order.

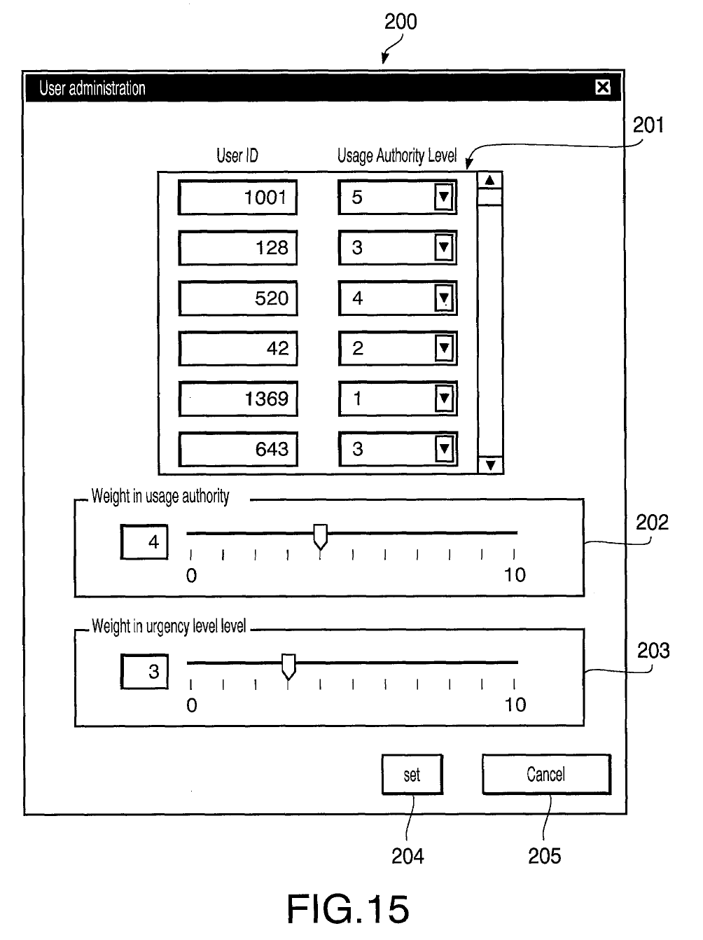

Next, a sixth embodiment according to the present invention will be described with reference to FIGS. 15-18. It is to be noted in the above embodiments that the printing order is determined based on the urgency level and the usage authority level set by the user. Meanwhile, in the present embodiment, weighting coefficients are used so that the printing order can be determined according to priority settings with the urgency levels and the usage authority levels multiplied by the weighing coefficients.

FIG. 15 illustrates a user administration window 200, through which an administrator of the printing system 1 sets a normal value of a usage authority level and a weighting coefficient for each user, according to the sixth embodiment of the present invention. In the present embodiment, the user administration window 200 can be activated solely by the administrator who is qualified to have information concerning security of the printing system 1 such as a password to activate the user administration window 200. The administrator of the printing system 1 activates the user administration window 200 by entering the security information in a predetermined window which is activated by a predetermined operation through the operation unit 12 of the PC 10.

As shown in FIG. 15, the user administration window 200 includes usage authority level setting fields 201, a first weight setting scale 202, and a second weight setting scale 203. Normal (unweighted) values for the usage authority levels can be set through the usage level setting fields 201, a weighting coefficient for the usage authority levels can be set through the first weight setting scale 202, and a weighting coefficient for the urgency levels can be set through the second weight setting scale 203.

A set button 204 is pressed to enter the values currently displayed in the user administration window 200. A cancel button 205 is pressed to discard the values newly inputted in the user administration window 200.

The weighting coefficients and the usage authority levels entered through the user administration window 200 are transmitted to the printer 200 and stored in the memory unit (e.g., the nonvolatile RAM 28) of the printer 20.

According to the weighting coefficients and the usage authority levels entered through the user administration window 200, priorities of print jobs received in the printer 20 are determined based on the following Formula 1.

Priority=(urgency level*second weighting coefficient)+(usage authority level*first weighting coefficient) Formula 1

In the present embodiment, the urgency levels “high,” “normal,” and “low” correspond to numbers “3,” “2,” and “1” respectively, and the larger number in the usage authority level indicates the higher priority.

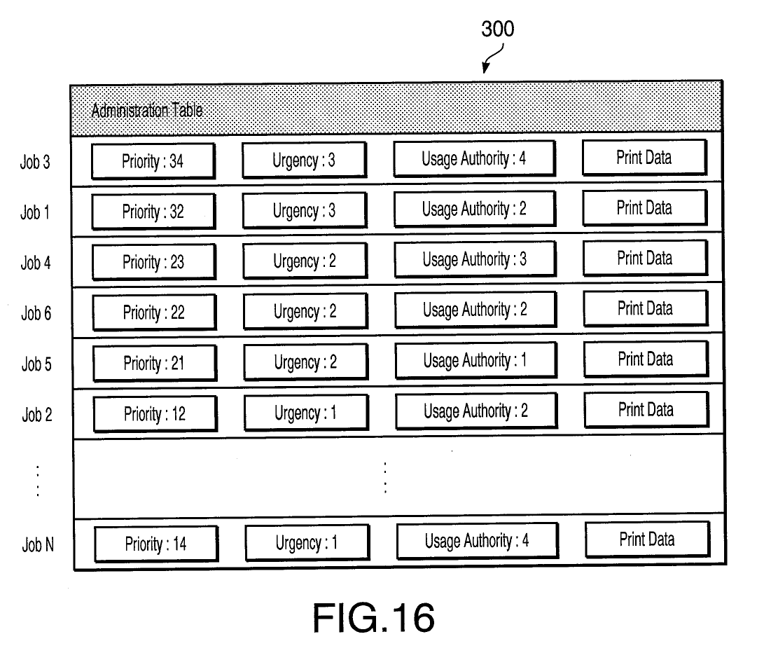

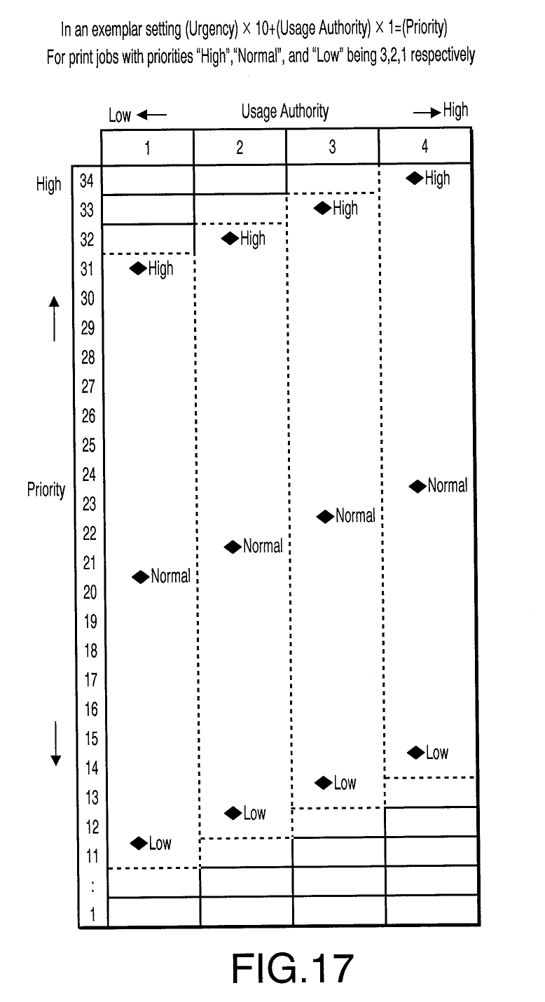

FIG. 16 schematically illustrates a print job administration table 300 to be used in the printing system 1 according to the sixth embodiment of the present invention. The print job administration table 300 is configured, for example, based on an assumption in which the weighting coefficient for the urgency level is 10, while the weighting coefficient for the usage authority levels is 1. FIG. 17 schematically illustrates calculated priorities of the print jobs to be processed in the printer 20 according to the sixth embodiments of the present invention. In the print job administration table 300, the priorities of the print jobs received in the printer 20 are calculated based on the formula 1, and the printer jobs are arranged in the table based on the priorities. A print job with the highest priority is arranged on the top line of the print job administration table 300, and a print job with the lowest priority is arranged on the bottom line of the print job administration table 300. Thus, the print jobs are processed in the arranged order (from top to bottom). A print job which completed the printing operation is removed from the print job administration table 300.

According to the present embodiment, the printing order can be determined based on the priorities of the print jobs which are weighted preferably; therefore, usage of the printing system 1 can be improved.

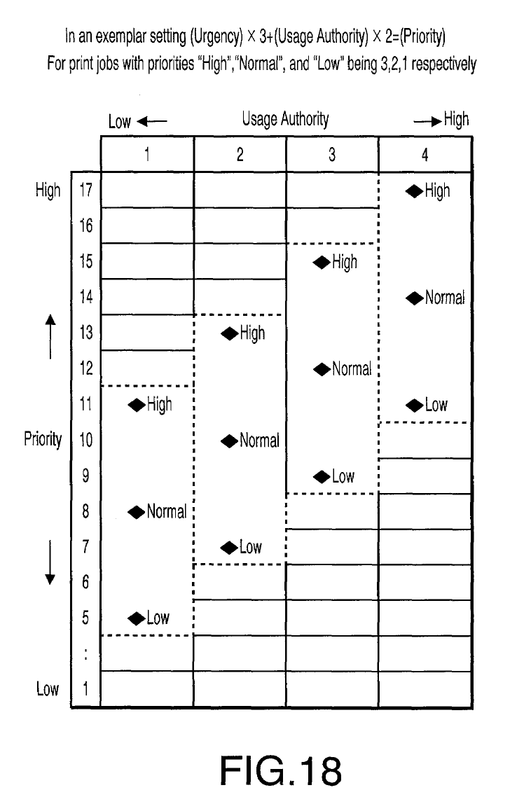

FIG. 18 schematically illustrates another calculated priorities of the print jobs to be processed in the printer 20 according to the sixth embodiments of the present invention. In the present example, the calculated result is obtained based on an assumption in which the weighting coefficient for the urgency level is 3, while the weighting coefficient for the usage authority levels is 2.

It is to be noted in FIGS. 17 and 18 that blackened diamond marks indicate the urgency levels of the print jobs. In FIG. 17, the print jobs with the urgency levels “normal” are not positioned higher in the priority order than the print jobs with the urgency levels “high.” Meanwhile, in FIG. 18, the print jobs with the urgency levels “normal” may be positioned higher in the priority order than the print jobs with the urgency levels “high.” Thus, according to the present embodiment, the priorities for the print jobs can be easily modified by adjusting the weighting coefficients.

In the present embodiment, the weighting coefficients are stored in the memory unit of the printer 20 so that the priorities of the print jobs can be calculated in the printer 20 in consideration of the urgency levels and the usage authority levels appended to the print jobs. However, the weighting coefficients can be stored in the memory unit of the PC 10, and the urgency levels and the usage authority levels multiplied by the weighting coefficients can be appended to the print jobs to transmit to the printer 20.

Although examples of carrying out the invention have been described, those skilled in the art will appreciate that there are numerous variations and permutations of the printing system that falls within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims. For example, the urgency levels and the usage authority levels being appended to the print jobs may be replaced with other values to represent the urgencies and the usage authorities.

For another example, the usage authority levels, which can be altered by any users when a print instruction is given, can be altered solely by the administrator of the printing system.

Further, the printing order may not necessarily be established within the printer 20, but may be established within, for example, a printer server being provided in the printing system so that the print jobs can be passed from the printer server to the printer 20 according to the printing order established within the printer server.

Furthermore, The urgency levels and the usage authority levels may not be necessarily be appended to the print jobs by the PC 10, but may be appended by the printer 20.

It is to be noted, for another example, many users may tend to set the urgency levels to be “high” and the usage authority levels to be “1.” Therefore, for example, users who used the printer 20 with the urgency level “high” and the usage authority level “1” for a predetermined number of times are prevented from using the urgency level “high” and the usage authority level “1” for a predetermined period of time.

Further, the priority setting window may be configured to allow the user to set solely the urgency level but not the usage authority level.

Furthermore, the priority table or the preset urgency table may not be necessarily stored in the memory unit of the printer 20, but may be stored in the memory unit of the PC 10.

What is claimed is:

1. A printing system capable of processing a plurality of print jobs, comprising;
a plurality of information processing apparatuses, each of which is capable of generating a print job based on print data representing an image to be printed and is adapted to transmit the print job to a printing apparatus; and
a printing apparatus, which is capable of forming images based on the plurality of print jobs transmitted from the plurality of information processing apparatuses,
wherein each of the information processing apparatuses is provided with a priority information appending unit to append first priority information and second priority information to the print job, the first priority information representing a priority level of the print job, the second priority information representing a priority level of a user who operates the information processing apparatus to generate the print job;
wherein the printing apparatus is provided with an order establishing unit to establish an order to print the images based on the first priority information and the second priority information appended to the print jobs.

2. The printing system according to claim 1,
wherein each of the information processing apparatuses is provided with an input unit to arbitrarily input at least one of a parameter value representing the first priority information and a parameter value representing the second priority information; and
wherein the priority information appending unit appends the at least one of the inputted parameter values to the print job.

3. The printing system according to claim 2,
wherein at least one of the parameter value representing the first priority information and the parameter value representing the second priority information can be arbitrarily modified.

4. The printing system according to claim 2,
wherein the input unit inputs the parameter value representing the second priority information based on a user name being entered when the user starts using the information processing apparatus.

5. The printing system according to claim 1,
wherein the priority information appending unit appends the first priority information to the print job according to a type of the print data.

6. The printing system according to claim 5,
wherein the first priority information is appended to the print job according to an application program which is used to create the image to be printed.

7. The printing system according to claim 1,
wherein each of the information processing apparatuses generates a plurality of interrelated print jobs, each of which is provided with grouping information to indicate relationship of the print job with the other interrelated print jobs, and transmit the interrelated print jobs to the printing apparatus; and
wherein the printing apparatus is provided with a judging unit to judge as to whether a print job transmitted from one of the information processing apparatuses belongs to a print job group, which can be processed as one print job, based on the grouping information and bundles the print job into the print job group.

8. The printing system according to claim 7,
wherein the print job group including the plurality of interrelated print jobs is processed in the order established according to a priority of a top-prioritized print job having a highest priority, which is determined based on the appended first and second priority information among the interrelated print jobs.

9. The printing system according to claim 1,
wherein the order establishing unit includes a weight setting unit to set weighting coefficients for the parameter values indicating the first priority information and the second priority information; and
wherein the order to print the images is established based on the parameter values of the print jobs obtained in consideration of the weighing coefficients.

10. The printing system according to claim 1,
wherein the order establishing unit reestablishes the order to print the images based on the first priority information and the second priority information appended to the print jobs each time a print job transmitted from one of the information processing apparatuses is received in the printing apparatus.

11. A printing system capable of processing a plurality of print jobs, comprising;
a plurality of information processing apparatuses, each of which is capable of generating a print job based on print data representing an image to be printed and is adapted to transmit the print job to a printing apparatus;
a printing apparatus, which is capable of forming images based on the plurality of print jobs transmitted from the plurality of information processing apparatuses;
an information appending unit to append first priority information and second priority information to the print job, the first priority information representing a priority level of the print job, the second priority information representing a priority level of a user who operates the information processing apparatus to generate the print job; and
an order establishing unit to establish an order to print the images based on the first priority information and the second priority information appended to the print jobs.

12. A printing apparatus, comprising:
a receiving unit to receive plurality of print jobs generated in and transmitted from a plurality of information apparatuses;
an order establishing unit to establish an order to process the print jobs to print images based on first priority information and second priority information appended to each of the print jobs, the first priority information representing a priority level of the print job, and second priority information representing a priority level of a user who operates the information processing apparatus to generate the print job; and
a printing unit to print the images corresponding to the print jobs based on the order established by the order establishing unit.

13. A method to operate a printing system including a plurality of information processing apparatuses and a printing apparatus to process a plurality of print jobs, comprising:
generating a print job and appending first priority information, representing a priority level of the print job, and second priority information, representing a priority level of a user who operates the information processing apparatus to generate the print job, to the print job;
establishing an order to process the print jobs to print images based on the first priority information and the second priority information appended to each of the print jobs; and
printing the images corresponding to the print jobs based on the order established by the order establishing unit.

14. A computer usable medium comprising computer readable instructions to control a printing system including a plurality of information processing apparatuses and a printing apparatus to process a plurality of print jobs, by executing steps of:
generating a print job and appending first priority information, representing a priority level of the print job, and second priority information, representing a priority level of a user who operates the information processing apparatus to generate the print job, to the print job;
establishing an order to process the print jobs to print images based on the first priority information and the second priority information appended to each of the print jobs; and
printing the images corresponding to the print jobs based on the order established by the order establishing unit.
